(19) United States
(12) Patent Application Publication
(10) Pub. No.: US 2008/0049006 A1
(43) Pub. Date: Feb. 28, 2008

(54) DISPLAY AND POWER SAVING APPARATUS AND METHOD THEREOF

(75) Inventors: Chien-Yu Yi, Hsinchu City (TW); Wen-Fa Hsu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: Au Optronics Corporation, Hsinchu City (TW)

(21) Appl. No.: 11/558,430

(22) Filed: Nov. 9, 2006

(30) Foreign Application Priority Data
Aug. 28, 2006 (TW) 95131533

(51) Int. Cl. G09G 5/00

(52) U.S. Cl. 345/211

(57) ABSTRACT

A display and its power-saving apparatus and method are provided. The power-saving method is adapted for a display with a backlight module. The power-saving method of the present invention includes the following steps. First, the brightness of the backlight module is adjusted by an adjusting signal. After then, the refresh frequency of the display panel is determined by the display brightness of the backlight module, wherein the refresh frequency of the display panel is proportional to the display brightness level achieved by said backlight module.

### CROSS-REFERENCE TO RELATED APPLICATION

This application claims the priority benefit of Taiwan application serial no. 95131533, filed Aug. 28, 2006. All disclosure of the Taiwan application is incorporated herein by reference.

### BACKGROUND OF THE INVENTION

1. Field of the Invention

The present invention relates to a power-saving apparatus and method, and more particularly to a power-saving apparatus and method applied to a display.

2. Description of Related Art

With the prevalence of flat panel displays, the thin film transistor liquid crystal display (TFT-LCD), for example, is manufactured with a keyboard design; wherein said keyboard allows users to set display brightness of said TFT-LCD based on background luminance and personal preference. Namely, the display brightness of said TFT-LCD is determined by the brightness of the backlight module.

Suppose flight passengers use their notebooks onboard in the low luminance environment (the light is turned down at times during a long distance flight for passengers to take a rest), the passengers can reduce the brightness of the internal backlight module in the notebooks through said keyboards, so as to avoid the discomfort arisen from excessive brightness and to prevent neighboring passengers from being disturbed. It is well known that power consumption of a notebook is reduced when a user adjusts down the brightness of the backlight module through said keyboard. That is because the current provided to the lamp of the backlight module is decreased when the brightness of the backlight module is turned down. Thereby, as are known to those skilled in the art, power consumption of the notebook can be reduced.

In view of the foregoing, the brightness of the backlight module can be adjusted through the keyboard as was disclosed in the prior art, so that power consumption of said display is reduced and the power-saving effect is then ensured. It is noted that, however, the refresh frequency of said internal display panel (normally at 60 Hz, 1/60 sec.) does not change when the user adjusts the brightness of the backlight module through the keyboard.

### SUMMARY OF THE INVENTION

Accordingly, at least one objective of the present invention is to provide a power-saving apparatus and method, which can adjust the brightness of a backlight module according to an adjusting signal and determine the refresh frequency of a display panel through a look-up unit.

At least another objective of the present invention is to provide a display which simultaneously changes the refresh frequency of the display panel and adjusts the brightness of the backlight module through said power-saving apparatus of the present invention, so that the display further ensures a better power-saving effect.

To achieve these and other advantages and in accordance with the purpose of the invention, as embodied and broadly described herein, the power-saving method of the present invention is adapted for a display, wherein the display includes a display panel and a backlight module. The power-saving method of the present invention comprises the following steps. First, the brightness of the backlight module is adjusted by an adjusting signal. After then, the refresh frequency of the display panel is determined by the display brightness of said backlight module, wherein the refresh frequency of the display panel is proportional to the display brightness level achieved by said backlight module.

From another perspective, the present invention provides a power-saving apparatus adapted for a display, wherein the display includes a display panel and a backlight module. The power-saving apparatus of the present invention comprises a control module and a look-up unit. The control module is coupled to the backlight module, and used to determine the brightness of the backlight module according to an adjusting signal. The look-up unit is coupled to the control module, and used to determine the refresh frequency of the display panel according to the display brightness of said backlight module, wherein the refresh frequency of the display panel is proportional to the display brightness level achieved by said backlight module.

From still another perspective, the present invention provides a display comprising a display panel, a backlight module, and a power-saving apparatus. The power-saving apparatus includes a control module and a look-up unit. The control module is coupled to the backlight module, and used to determine the brightness of the backlight module according to an adjusting signal. The look-up unit is coupled to the control module, and used to determine the refresh frequency of the display panel according to the display brightness of said backlight module, wherein the refresh frequency of the display panel is proportional to the display brightness level achieved by said backlight module.

The power-saving apparatus and method of the present invention can be applied in the prevailing displays having backlight modules. This is because the power-saving apparatus determines the refresh frequency of the display panel inside the display through the look-up unit which adjusts the brightness of the backlight module. Thereby, as the brightness of the backlight module alters, the refresh frequency of the display panel inside the display is also changed, so the power-saving apparatus and method can not only reduce the power consumption of the backlight module, but also reduce the power consumption of the display panel inside the display. As a result, the display ensures a better power-saving effect.

In order to make the aforementioned and other objects, features and advantages of the present invention comprehensible, a preferred embodiment accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating the steps of a power-saving method according to one preferred embodiment of the present invention.

FIG. 2 is a block diagram showing a display according to one preferred embodiment of the present invention.

FIG. 3 is a block diagram showing a power-saving apparatus according to the present embodiment.

FIG. 4 illustrates a look-up table built in a look-up unit according to the present embodiment.

FIG. 5 is a diagram showing a driving waveform of driving a backlight module according to the present embodiment.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

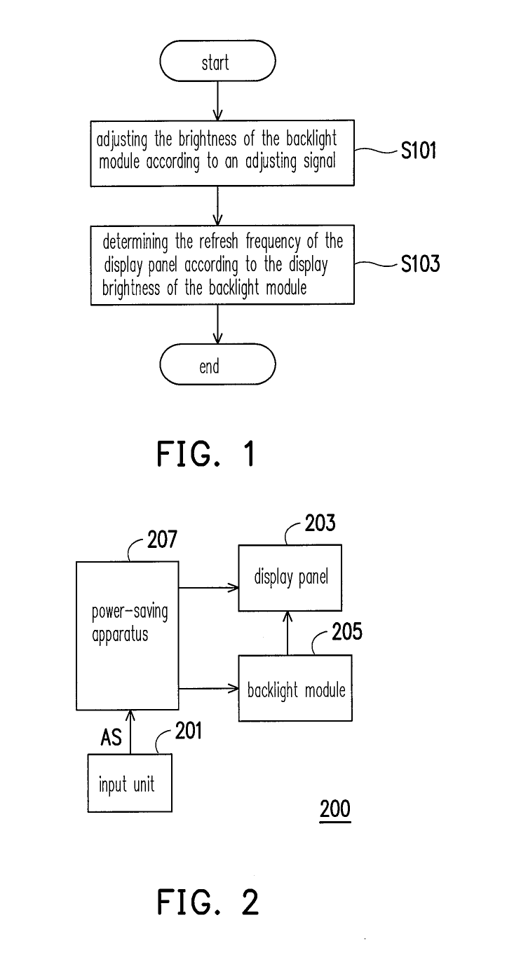

FIG. 1 is a flow chart illustrating the steps of a power-saving method according to one preferred embodiment of the present invention. As showing in FIG. 1, the power-saving method of the present embodiment is applied in the prevailing display having a backlight module, for example, a thin film transistor liquid crystal display (TFT-LCD), a liquid crystal display (LCD), and the like. Said display comprises a display panel and a backlight module. The power-saving method of the present invention includes firstly adjusting the brightness of the backlight module according to an adjusting signal, as is disclosed in step S101, wherein said adjusting signal is generated through a user's operation on a keyboard of the display. In addition, to adjust the display brightness level of the backlight module, namely alter in the current provided to the lamp of the backlight module. That is to say, the display brightness of the backlight module achieves a high display brightness level when the current value provided to the lamp of the backlight module is large; on the contrary, said display brightness level appears to be low when the current value provided to the lamp of the backlight module is small.

After then, as is disclosed in step S103, the refresh frequency of the display panel is determined by the display brightness of said backlight module, and the refresh frequency of the display panel is proportional to the display brightness level achieved by said backlight module. For example, the refresh frequency of the display panel is determined to 60 Hz, but herein not-limited to be 60 Hz. As is illustrated in step S103, the display brightness of the backlight module according to the adjusting signal in step S101 determines the refresh frequency of the display panel. Namely, when the display brightness of the backlight module is high, the refresh frequency of the display panel also reaches a high level up to 60 Hz. On the contrary, when the display brightness of the backlight module is low, the refresh frequency of the display panel also reaches a low level down to 30 Hz.

However, the minimum refresh frequency of the display panel is not restricted in the present invention. Said frequency varies in consideration of the actual manufacturing process of a display panel.

In order to embody said power-saving method, an embodiment disclosing a display and the power-saving apparatus thereof is provided below. FIG. 2 is a block diagram showing a display 200 according to one preferred embodiment of the present invention. As showing in FIG. 2, the display 200 comprises an input unit 201, a display panel 203, a backlight module 205, and a power-saving apparatus 207. The input unit 201 can be operated by a user through a keyboard to output an adjusting signal AS to the power-saving apparatus 207. Moreover, the structures of the display panel 203 and the backlight module 205 are not the subjects of the present invention, and the technology of driving the display panel 203 and the backlight module 205 are well known to those skilled in the art. Hence, for fear of raising confusion between the prior art and the present invention, detailed descriptions of the display panel 203 and the backlight module 205 are then omitted.

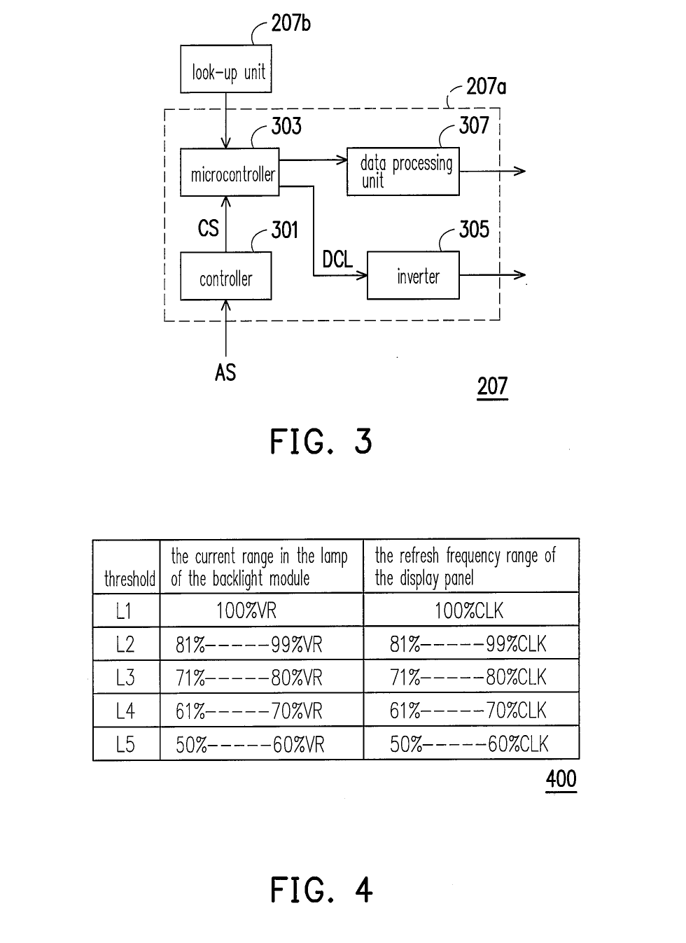

FIG. 3 is a block diagram showing the power-saving apparatus 207 according to the present embodiment. Referring to FIGS. 2 and 3 together, the power-saving apparatus 207 comprises a control module 207a and a look-up unit 207b. The control module 207a is coupled to the backlight module 205 and used to determine the brightness of the backlight module 205 according to the adjusting signal AS. The look-upunit 207b is coupled to the control module 207a and used to determine the refresh frequency of the display panel 203 according to the display brightness of said backlight module 205, wherein the refresh frequency of the display panel 203 is proportional to the display brightness level achieved by said backlight module 205.

Furthermore, the control module 207a comprises a controller 301, a microcontroller 303, an inverter 305, and a data processing unit 307. The controller 301 is coupled to the input unit 201 and used to receive and transfer the adjusting signal AS to output a control signal CS. In general, the adjusting signal AS generated by the input unit 201 is an analog signal which should be transferred to the control signal CS as a digital signal through the controller 301. Thereby, the microcontroller 303 can identify the instruction from the user.

The microcontroller 303 is used to receive the control signal CS outputted by the controller 301, and thereby a direct current voltage level DCL is generated. In the present embodiment, the microcontroller 303 is used not only to generate the direct current voltage level DCL, but also to determine the timing of displaying video data and the brightness of the backlight module 205. The inverter 305 is used to compare the direct current voltage level DCL generated by the microcontroller 303 with a constant frequency triangular pulse TP produced by the inverter 305 itself, so that the brightness of the backlight module 205 can be determined.

In the present embodiment, the look-up unit 207b can be operated through its memory which built-in a look-up table, wherein the look-up table is used to store corresponding data between the current provided to the lamp of the backlight module 205 and the refresh frequency of the display panel 203.

FIG. 4 illustrates a look-up table 400 built-in the look-up unit 207b according to the present embodiment. As showing in FIG. 4, there are, but not limited to five thresholds L1˜L5. The designer can change the amount of thresholds according to actual demands. Each of the thresholds L1˜L5 relates to a current range in the lamp of the backlight module 205 and a refresh frequency range of the display panel 203. As is shown in the look-up table 400, the current range 100% VR corresponding to the threshold L1 exhibits the brightness of the backlight module 205 before regulation, while the refresh frequency range 100% CLK demonstrates the refresh frequency of the display panel 203 before regulation. Accordingly, given that the normal refresh frequency of the display panel 203 is 60 Hz, the refresh frequency of the display panel 203 corresponding to the threshold L1 is 60 Hz.

The current range 81%˜99% VR corresponding to the threshold L2 exhibits the regulated brightness of the backlight module 205, while the refresh frequency range 81%˜99 CLK demonstrates the regulated refresh frequency of the display panel 203. Accordingly, given that the normal refresh frequency of the display panel 203 is 60 Hz, the refresh frequency of the display panel 203 corresponding to the threshold L2 ranges from 48.6 Hz to 59.4 Hz. Said calculating methods of the refresh frequency range of the display panel 203 corresponding to the thresholds L1 and L2 are also applied to the thresholds L3-L5 provided thereinafter. Hence, further descriptions are omitted. However, it is noted that the current range in the lamp of the backlight module 205 and the refresh frequency range of the display panel 203 are not linearly corresponding to each other.

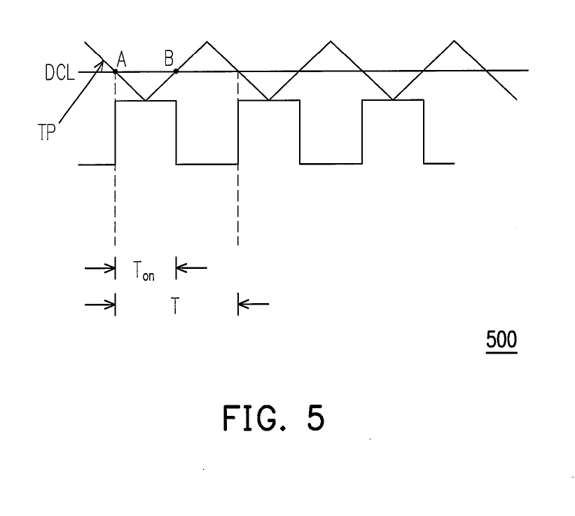

FIG. 5 is a diagram showing a driving waveform of driving the backlight module 205 according to the present embodiment. Referring to FIGS. 2-5 together, the driving waveform diagram 500 disclosed in FIG. 5 aims to illustrate the current value provided to the lamp of the backlight module 205 by the inverter 305. The driving waveform diagram 500 includes the direct current voltage level DCL outputted by the microcontroller 303 and the constant frequency triangular pulse TP produced by the inverter 305 itself. In cycle T, the linear distance between points A and B at which the direct current voltage level DCL and the constant frequency triangular pulse TP intersect represents the time T_{ON} during which the inverter 305 generates power. Namely, the time T_{ON} indicates the current value provided to the lamp of the backlight module 205.

It is also noted that the power generation time T_{ON} of the inverter 305 is increased if the direct current voltage level DCL outputted by the microcontroller 303 is raised. Thereby, the current value provided to the lamp of the backlight module 205 is also increased. In consequence, the brightness of the backlight module 205 reaches a high level when the current provided to the lamp of the backlight module 205 is high. On the contrary, the power generation time T_{ON} of the inverter 305 is decreased if the direct current voltage level DCL outputted by the microcontroller 303 is dropped. Thereby, the current value provided to the lamp of the backlight module 205 is also decreased. In consequence, the brightness of the backlight module 205 reaches a low level when the current provided to the lamp of the backlight module 205 is low. In view of the above, the brightness level achieved by the backlight module 205 is proportional to the current value provided to the lamp of the backlight module 205, and proportional to the refresh frequency of the display panel 203 as well.

It is also known that the brightness of the backlight module 205 can be regulated through changing the direct current voltage level DCL outputted by the microcontroller 303, while said direct current voltage level DCL is determined by the adjusting signal AS generated by the input unit 201.

Referring to FIGS. 2 and 3 together, the data processing unit 307 is coupled between the microcontroller 303 and the display panel 203 and used to process a plurality of data signals outputted by the microcontroller 303, for example, video data, vertical synchronous signal (V_sync) , horizontal synchronous signal (H_sync), data enable signal (DE), clock signal (CLK), logic power source (VDD), and the like. Thereby, the refresh frequency of the display panel 203 can be determined by the look-up unit 207b.

In the present embodiment, the data processing unit 307 includes a timing controller (not shown) used to receive the data signals as stated above and to control the refresh frequency of the display panel accordingly. Furthermore, as is known to those skilled in the art, the data processing unit 307 further includes a gate driver (not shown) and a source driver (not shown), which are both dominated by the timing controller. Thus, the display panel 203 is controlled.

To better illustrate the above embodiment disclosing said display 200 and its power-saving apparatus 207, another example is provided below.

Given that a user regulates the brightness of the backlight module 205 through the input unit 201, the input unit 201 then outputs an adjusting signal AS to the control unit 301, and the control unit 301 transfers the adjusting signal AS to a control signal CS, so that the microcontroller 303 can identify the instruction from the user. Next, according to the control signal CS, the microcontroller 303 provides a direct current voltage level DCL to the inverter 305, so as to adjust the current provided to the lamp of the backlight module 205, and to further regulate the display brightness level of the backlight module 205.

Thereafter, according to the regulated display brightness level of the backlight module 205, the look-up unit 207a correlates that built-in look-up table with a corresponding refresh frequency of the display panel 203, so that the timing controller of the data processing unit 307 can adjust the refresh frequency of the display panel 203 to the refresh frequency matched by the look-up unit 207a. Accordingly, lowering the brightness level of the backlight module 205 can decrease not only the current provided to the lamp of the backlight module 205, but also power consumption of the backlight module 205. Besides, the refresh frequency of the display panel 203 is also reduced, so that power consumption thereof is decreased. Thereby, the display 200 further ensures a better power-saving effect.

In summary, the present invention provides a power-saving apparatus and method which can be applied in the display having the backlight module. According to the above embodiments, the power-saving apparatus determines the refresh frequency of the display panel inside the display through the look-up unit which can regulate the brightness of the backlight module. Thus, as the brightness of the backlight module alters, the refresh frequency of the display panel inside the display is also changed, leading to reduction of power consumption of both the backlight module and the display panel inside the display. As a result, the display ensures a better power-saving effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power-saving method, adapted for a display, wherein the display comprising a display panel and a backlight module, the power-saving method comprising the following steps:
adjusting the brightness of the backlight module according to an adjusting signal; and
determining the refresh frequency of the display panel according to the display brightness of the backlight module,
wherein the refresh frequency of the display panel is proportional to the display brightness level achieved by the backlight module.

2. A power-saving apparatus, adapted for a display, wherein the display comprising a display panel and a backlight module, said power-saving apparatus comprising:
a control module, coupled to the backlight module and used to determine the brightness of the backlight module according to an adjusting signal; and
a look-up unit, coupled to the control module and used to determine the refresh frequency of the display panel according to the display brightness of the backlight module,
wherein the refresh frequency of the display panel is proportional to the display brightness level achieved by the backlight module.

3. The power-saving apparatus of claim 2, wherein the display further comprises an input unit, coupled to the control module and used to generate the adjusting signal.

4. The power-saving apparatus of claim 3, wherein the input unit comprises a keyboard.

5. The power-saving apparatus of claim 2, wherein the control module comprises:
a controller , coupled to the input unit and used to receive and transfer the adjusting signal to output a control signal;
a microcontroller, coupled to the controller and used to generate a direct current voltage level according to the control signal; and
an inverter, coupled to the microcontroller and used to compare the direct current voltage level with a triangular pulse produced by the inverter and determine the brightness of the backlight module.

6. The power-saving apparatus of claim 5, wherein the control module further comprises a data processing unit, coupled to between the display panel and the control module and used to adjust the refresh frequency of the display panel as is determined by the look-up unit according to a plurality of data signals outputted by the microcontroller.

7. The power-saving apparatus of claim 6, wherein the data processing unit comprises a timing controller used to control the refresh frequency of the display panel according to the data signals.

8. The power-saving apparatus of claim 2, wherein the look-up unit comprises a memory.

9. A display, comprising:
a display panel;
a backlight module; and
a power-saving apparatus, comprising:
a control module, coupled to the backlight module and used to determine the brightness of the backlight module according to an adjusting signal; and
a look-up unit, coupled to the control module and used to determine the refresh frequency of the display panel according to the display brightness of the backlight module,
wherein the refresh frequency of the display panel is proportional to the display brightness level achieved by the backlight module.

10. The display of claim 9, wherein the display further comprises an input unit, coupled to the control module and used to generate the adjusting signal.

11. The display of claim 10, wherein the input unit comprises a keyboard.

12. The display of claim 9, wherein the control module comprises:
a controller, coupled to the input unit and used to receive and transfer the adjusting signal to output a control signal;
a microcontroller, coupled to the controller and used to generate a direct current voltage level according to the control signal; and
an inverter, coupled to the microcontroller and used to compare the direct current voltage level with a triangular pulse produced by the inverter and determine the brightness of the backlight module.

13. The display of claim 12, wherein the control module further comprises a data processing unit, coupled to between the display panel and the control module and used to adjust the refresh frequency of the display panel as is determined by the look-up unit according to a plurality of data signals outputted by the microcontroller.

14. The display of claim 13, wherein the data processing unit comprises a timing controller used to control the refresh frequency of the display panel according to the data signals.

15. The display of claim 9, wherein the look-up unit comprises a memory.
